(19) United States
(12) Patent Application Publication
(10) Pub. No.: US 2023/0255241 A1
(43) Pub. Date: Aug. 17, 2023

(54) NON-ALCOHOLIC BEER-FLAVORED BEVERAGE

(71) Applicant: SUNTORY HOLDINGS LIMITED, Osaka-shi, Osaka (JP)

(72) Inventors: Risa Takagi, Soraku-gun, Kyoto (JP); Saiko Sudo, Soraku-gun, Kyoto (JP); Keiko Iwasa, Soraku-gun, Kyoto (JP); Masaaki Ozawa, Soraku-gun, Kyoto (JP); Naoto Kanda, Soraku-gun, Kyoto (JP); Yoshihide Matsuo, Soraku-gun, Kyoto (JP)

(73) Assignee: SUNTORY HOLDINGS LIMITED, Osaka-shi, Osaka (JP)

(21) Appl. No.: 18/012,475

(22) PCT Filed: Jun. 29, 2021
(86) PCT No.: PCT/JP2021/024565

§ 371 Date: Dec. 22, 2022

(30) Foreign Application Priority Data
Jul. 1, 2020 (JP) 2020-114432

(51) Int. Cl. A23L 2/66

(52) U.S. Cl. CPC A23L 2/66

(57) ABSTRACT

The present invention aims to provide a beverage with increased fullness. In particular, the present invention aims to provide a non-alcoholic beer-taste beverage with increased fullness. The present invention relates to a non-alcoholic beer-taste beverage containing 2′-deoxyadenosine at a concentration of 1 ppm or more.

### TECHNICAL FIELD

The present invention relates to a non-alcoholic beer-taste beverage.

### BACKGROUND ART

Diversification of consumer preferences in recent years has created a desire for development of non-alcoholic beer-taste beverages having various aroma and taste characteristics.

Patent Literature 1 discloses adding a peptide of a specific molecular weight to improve the aroma and taste of beer-taste beverages.

### CITATION LIST

### Patent Literature

### Patent Literature 1: JP 2016-149975 A

### SUMMARY OF INVENTION

### Technical Problem

In Patent Literature 1, beverages are evaluated using indexes including beer-like taste, smooth flow of the taste, and lingering roughness in the mouth. According to the literature, beverages with a high score on the sensory evaluation based on these indexes can be obtained when the beverages contain a 10-20 kDa peptide at a specific concentration.

Some people prefer a specific taste as the taste immediately after drinking a beer-taste beverage. The specific taste cannot be expressed by any of the five basic tastes, i.e., sweet, salty, sour, bitter, and umami, but is characterized by intensity, mouthfulness, thickness, persistence of the taste, or a good balance of intensity of the taste. Herein, such a characteristic is referred to as “fullness”.

The beverage disclosed in Patent Literature 1 still has room for further improvement in terms of fullness, and there has been a demand for a method of increasing the fullness.

The present invention aims to provide a beverage with increased fullness. In particular, the present invention aims, to provide a non-alcoholic beer-taste beverage with increased fullness. A non-alcoholic beer-taste beverage tends to have poor fullness, so that increasing the fullness of such a beverage is particularly expected.

### Solution to Problem

Specifically, the present invention relates to the following non-alcoholic beer-taste beverage.

(1) A non-alcoholic beer-taste beverage containing 2′-deoxyadenosine at a concentration of 1 ppm or more.

(2) The non-alcoholic beer-taste beverage according to (1) above, wherein the concentration of 2′-deoxyadenosine is 1 to 10 ppm.

(3) The non-alcoholic beer-taste beverage according to (1) or (2) above, further containing a protein having a molecular weight of 35 to 50 kDa, wherein the protein has a concentration of 5 ppm or more.

(4) The non-alcoholic beer-taste beverage according to (3) above, wherein the protein has concentration of 30 ppm or less.

### Advantageous Effects of Invention

The present invention can provide a non-alcoholic beer-taste beverage with increased fullness.

### DESCRIPTION OF EMBODIMENTS

The non-alcoholic beer-taste beverage of the present invention may contain malt in its ingredients or may not contain malt in its ingredients (the proportion by weight of malt in a mixture of ingredients is 0).

The term “ingredients” herein means grain ingredients sugars other than water and hops.

Components that may be added in trace amounts, such as acidulants, sweeteners, bittering agents, seasonings, and flavorings are not included in the ingredients.

When the ingredients include malt, the ingredients may include, in addition to the malt as an ingredient, rice, corn, sorghum, potato, starch, and cereal grains other than malt. The amount of extract in the non-alcoholic beer-taste beverage of the present invention is not limited but is preferably 0.01 to 20.0 wt %.

The phrase “does not contain malt in its ingredients” means that the proportion by weight of malt in a mixture ingredients is 0, wherein the ingredients include plant proteins such as malt, rice, corn, sorghum, potato, starch, and beans, cereal grains other than malt, and sugars but exclude water and hops.

When the ingredients do not include malt, preferably, a degraded soybean protein is included as a main ingredient.

When the ingredients do not include malt, use of a malt-derived protein having a molecular weight of 35 to 50 kDa (described later) is acceptable.

Preferably, the non-alcoholic beer-taste beverage of the present invention is not a dealcoholized beer-taste beverage. The dealcoholized beer-taste beverage is a non-alcoholic beer-taste produced by removing alcohol from a beer-taste beverage.

The non-alcoholic beer-taste beverage is a beer-taste beverage having an alcohol content of less than 1%, preferably one containing substantial no alcohol. The alcohol content may be 0%.

The beer-taste beverage is a beer-flavored carbonated beverage.

Beverages containing substantially no alcohol include beverages containing an undetectable trace amount of alcohol. Beverages having an alcohol content rounded to 0.0%, particularly those having an alcohol content rounded to 0.00%, are included in non-alcoholic beer-taste beverages. Examples of the non-alcoholic beer-taste beverage of the present invention include non-alcoholic beer-taste beverages and beer-taste soft drinks. The “alcohol content” here means the ethanol content, with aliphatic alcohols other than ethanol being excluded.

The alcohol content of the non-alcoholic beer-taste beverage of the present invention means the proportion (v/v %) of the alcohol in the, beverage, and the alcohol content can be measured by any known method. For example, it can be measured using a vibrating density meter. Specifically, a beverage is filtered or sonicated to prepare a sample from which carbon dioxide has been removed. The sample is distilled over open fire to obtain a distillate. The density the distillate at 15° C. is measured. The density is then converted to the alcohol content using an appendix “Table 2: Table of Conversion between Alcohol Content and Density (15° C.) or Specific Gravity (15/15° C.)” of the Official Analysis Method of National Tax Agency of Japan (National Tax Agency Directive No. 6 in 2007, revised on Jun. 22, 2007). When the alcohol content less than 1.0%, a commercially available alcohol measuring instrument or a gas chromatograph may be used.

The non-alcoholic beer-taste beverage of the present invention contains 2′-deoxyadenosine. 2′-Deoxyadenosine a type of 2′-deoxyribonuclecide. Herein, 2′-deoxyadenosine is sometime described as “2′DA”.

In the non-alcoholic beer-taste beverage of the present invention, 2′-deoxyadenosine has a concentration of 1 ppm or more.

A non-alcoholic beer-taste beverage containing deoxyadenosine at a concentration of 1 ppm or more can have increased fullness.

The correlation between the presence of 2′-deoxyadenosine at a predetermined concentration in a non-alcoholic beer-taste beverage and the fullness of the non-alcoholic beer-taste beverage was unknown so far and was found by the present inventors.

In the non-alcoholic beer-taste beverage of the present invention, the concentration of 2′-deoxyadenosine is preferably 10 ppm or less.

In the non-alcoholic beer-taste beverage of the present invention, the concentration of 2′-deoxyadenosine is preferably 2 ppm or more, more preferably 6 ppm or more.

In one embodiment, the concentration of 2′-deoxyadenosine in the non-alcoholic beer-taste beverage is preferably 1 to 10 ppm, more preferably 2 to 10 ppm, still more preferably 6 to 10 ppm.

Preferably, the non-alcoholic beer-taste beverage of the present invention further contains a protein having a molecular weight of 35 to 50 kDa, and the protein has a concentration of 5 ppm or more.

The protein having a molecular weight of 35 to 50 kDa is a protein detected in the molecular weight range of 35 to 50 kDa when the non-alcoholic beer-taste beverage is subjected to electrophoresis by SDS-PAGE. Before subjecting the non-alcoholic beer-taste beverage to electrophoresis by SDS-PAGE, for example, the non-alcoholic beer-taste beverage may be subjected to ultrafiltration using a 30 kDa cutoff membrane as a pre-treatment.

The protein is preferably a protein having a molecular weight of 35 to 45 kDa, more preferably a protein having a molecular weight of about 40 kDa. Herein, the protein having a molecular weight of 35 to 50 kDa is also referred to as a “40 kDa protein”.

Preferably, the 40 kDa protein is a grain-derived protein.

Preferably, the grain at least one selected from the group consisting of barley, wheat, corn, rice, and soybean.

When the grain is a cereal grain, the non-alcoholic beer-taste beverage can contain a protein derived from a known cereal grain usable in production of non-alcoholic beer-taste beverages. Examples of the cereal grain include barley, wheat, rye, common wild oat (Avena fatua), and common oat (Avena sativa). Preferred is barley. Further, the cereal grain may be either germinated or ungerminated, but is preferably malt from a germinated cereal grain. Any of these may be present alone or in combination of two or more in the non-alcoholic beer-taste beverage.

The 40 kDa protein is preferably Serpin Z4 (also known as: BSZ4, HorvuZ4, Major endosperm albumin, or Protein Z) derived from barley (scientific name: Hordeum vulgare) and/or Serpin Z7 (also known as: BSZ7 or HorvuZ7) derived from barley. The above protein may be a protein having an amino acid sequence in which one or more amino acids are deleted, replaced, inserted, and/or added.

Further adding a 40 kDa protein in addition to 2′-deoxyadenosine can further increase the fullness of the non-alcoholic beer-taste beverage.

The concentration of the 40 kDa protein is preferably 30 ppm or less.

When the non-alcoholic beer-taste beverage contains both 2′-deoxyadenosine and a 40 kDa protein, the fullness of the non-alcoholic beer-taste beverage can be effectively increased by synergy of the 2′-deoxyadenosine and the 40 kDa protein.

A common process of producing a non-alcoholic beer-taste beverage is described below.

A non-alcoholic beer-taste beverage can be easily produced because no fermentation step with yeast is involved.

In production of non-alcoholic beer-taste beverages produced using malt as an ingredient, a mixture containing water, cereal grains (e.g., malt), and other optional ingredients such as other grains, starch, sugars, bittering agents, and colorants is mixed with an enzyme such as an amylase as needed. The resulting mixture is gelatinized, saccharified, and filtered to obtain a saccharified solution. The saccharified solution is mixed with hops, a bittering agent, or the like as needed and then boiled, followed by removal of the solids content such as a coagulated protein in a clarification tank. The saccharified solution may be replaced by a boiled mixture of a malt extract, warm water, and hops. Hops may be added to the mixture at any stage from the start of boiling to the end of boiling. The conditions in the saccharification, boiling, solids content removal, and the like may be known conditions. After the boiling, the obtained wort is filtered, and the filtrate is then mixed with carbon dioxide gas. Thereafter, the resulting mixture is packaged in a container and sterilized to obtain a desired non-alcoholic beer-taste beverage.

In production of a non-alcoholic beer-taste beverage in which malt is not used as an ingredient, a liquid sugar containing a carbon source, a nitrogen source as an amino acid-containing material other than a cereal grain or malt, hops, colorants, and the like are mixed together with warm water to obtain a liquid sugar solution. The liquid sugar solution is boiled. When hops are used as an ingredient, the hops may be mixed into the liquid sugar solution during boiling, not before the start of boiling. The boiled liquid sugar solution is mixed with a carbon dioxide gas. Thereafter, the resulting mixture is packaged in a container and sterilized to obtain a desired non-alcoholic beer-taste beverage.

An aliphatic alcohol may be added to the non-alcoholic beer-taste beverage of the present invention to impart the alcohol-like texture to the beverage. The aliphatic alcohol may be any known aliphatic alcohol, but is preferably a C4-C5 aliphatic alcohol. Preferred aliphatic alcohols in the preen invention include 2-methyl-1-propanol and 1-butanol as C4 aliphatic alcohols and 3-methyl-1-butanol, 1-pentanol, and 2-pentanol as C5 aliphatic alcohols. These can be used alone or in combination of two or more thereof.

The C4-C5 aliphatic alcohol content is, preferably 0.0002 to 0.0007 wt %, more preferably 0.0003 to 0.0006 wt %. Herein, the aliphatic alcohol content can be measured headspace as chromatography.

The non-alcoholic beer-taste beverage of the present invention is preferably low in calories to suit the recent preference for low-calorie products. The non-alcoholic beer-taste beverage of the present invention therefore has a calorie content of preferably less than 5 kcal/100 mL, more preferably Less than 4 kcal/100 mL, still more preferably less than 3 kcal/100 mL.

The calorie content of the non-alcoholic beer-taste beverage of the present invention is basically calculated in accordance with “Method for Analysis of Components such as Nutritional Components and the like under the Nutrition Labeling Standards” which was published in connection with the Health Promotion Act in Japan. In other words, in principle, the calorie content can be calculated as a sum of the products of the quantified amounts of the nutritional components multiplied by the energy conversion coefficients of the respective, components (protein: 4 kcal/g; fat: 9 kcal/g; sugar: 4 kcal/g; dietary fiber: 2 kcal/g; alcohol: 7 kcal/g; organic acid: 3 kcal/g). The details are described in “Method for Analysis of Components such as Nutritional Components and the like under the Nutrition Labeling Standards”.

The specific method of measuring the amount of each nutritional component contained in the non-alcoholic beer-taste beverage of the present invention may be in accordance with various analytical methods described in “Method for Analysis of Components such as Nutritional Components and the like under the Nutrition Labeling Standards” of the Health Promotion Act. Japan Food Research Laboratories can provide, upon request, data on the calorie contents and/or the amounts of nutritional components.

The sugar contained in the non-alcoholic beer-taste beverage of the present invention means a sugar based on the Nutrition Labeling Standards for Foods (Ministry of Health, Labor and Welfare, Notification No. 176, 2003). Specifically, the sugar refers to a component which remains after the protein, fat, dietary fiber, ash content, alcohol content, and moisture content are removed from a food. The amount of sugar in a food is calculated by subtracting the amounts of protein, fat, dietary fiber, ash content, ad moisture content from the weight of the food. In this case, the amounts of protein, fat, dietary fiber, ash content, and moisture content are measured by the methods under the Nutrition Labeling Standards. Specifically, the amount of protein is measured by the nitrogen quantification conversion method. The amount of fat is measured by an ether extraction method, chloroform-methanol liquid mixture extraction method, the Gerber method, an acid decomposition method, or the Roese-Gottlieb method. The amount of dietary fiber is measured by high performance liquid chromatography or the Prosky method. The amount of ash content is measured by a method of ashing with magnesium acetate, a direct ashing method, or a method of ashing with sulfuric acid. The amount of moisture content is measured by the Karl Fischer method, a method using a drying aid, a vacuum thermal drying method, an atmospheric thermal drying method, or a plastic film method.

The non-alcoholic beer-taste beverage of the present invention may be low in sugars to suit the recent preference for low-sugar food and beverages. The non-alcoholic beer-taste beverage of the present invention may have a sugar content of less than 2.5 g/100 mL or less than 0.5 g/100 mL. The lower limit is not particularly set, but is usually about 0.1 g/100 mL and may be, for example, 0.15 g/100 mL or more, or 0.2 g/100 mL or more.

The non-alcoholic beer-taste beverage of the present invention may contain an acidulant. The acidulant is preferably at least one acid selected from the group consisting of citric acid, lactic acid, phosphoric acid, and malic acid. In the present invention, an acid other than the acids above, such as succinic acid, tartaric acid, fumaric acid, or glacial acetic acid may also be used. Any of these can be used without limitation as long as they are accepted as food additives. In the present invention, preferred is a combination of lactic acid, which appropriately imparts a mild sour flavor, and phosphoric acid, which appropriately imparts a slightly tingling sour flavor.

The acidulant content in the non-alcoholic beer-taste beverage of the present in in citric acid equivalent is preferably 20.0 ppm or more, more preferably 550 ppm or more, still more preferably 700 ppm or more to impart the beer-like taste. The acidulant content is preferably 15000 ppm or less, more preferably 5500 ppm or less, still more preferably 2000 ppm or less in terms of sour flavor. The acidulant content in the present invention in citric acid equivalent therefore falls within a range of 200 ppm to 15000 ppm, preferably 550 ppm to 5500 ppm, more preferably 700 ppm to 1500 ppm, for example. The “acidulant content in citric acid equivalent” is an amount calculated from the degree of the sour flavor of each acidulant based on the degree of the sour flavor of citric acid. For example, a lactic acid content of 100 ppm corresponds to a citric acid equivalent of 120 ppm. A phosphoric acid content of 100 ppm corresponds to a citric acid equivalent of 200 ppm. A malic acid content of 100 ppm corresponds to a citric acid equivalent of 125 ppm.

The acidulant content in a non-alcoholic beer-taste beverage refers to one calculated based on analysis by high performance liquid chromatography (HPLC) or the like.

In the non-alcoholic beer-taste beverage of the present invention, hops can be used as one of the ingredients.

When hops are used, hop pellets, hop powder, and hop extracts usually used in production of beer and the like can be appropriately selected according to the desired aroma and taste. Also, processed hop products such as isometric hops and reduced hops may be used. The hops used in the non-alcoholic beer-taste beverage of the present invention include these hops. The amount of hops to be added is not particularly limited, but is typically about 0.0001 to 1 wt % based on the total amount of the beverage.

The non-alcoholic beer-taste beverage of the present invention may contain any other ingredients as needed, as long as the effect of the present invention is not impaired. For example, sweeteners (including high-intensity sweeteners), bittering agents, flavorings, yeast extracts, colorants such as caramel color, plant-extracted saponin-based substances such as soybean saponin and quillaja saponin, substances containing proteins and peptides from plants such as corn and soybean, protein-based substances such as bovine serum albumin, seasonings such as dietary fiber and amino acids, and antioxidants such as ascorbic acid an be used as needed as long as the effect of the present invention is not impaired.

The non-alcoholic beer taste beverage of the present invention can be packaged in a container. The form of the container is not limited. The non-alcoholic beer-taste beverage can be packed in a sealed container such as a bottle, can, keg, or plastic bottle, whereby a packaged beverage can be obtained.

The non-alcoholic beer-taste beverage of the present invention may be produced by any method, such as one in which a predetermined amount of 2′-deoxyadenosine is added to a non-alcoholic beer-taste beverage.

Preferably, a 40 kDa protein is added to the non-alcoholic beer-taste beverage.

The 2′-deoxyadenosine and the 40 kDa protein to be added can be prepared by, for example, a procedure described in Examples below.

The 2′-deoxyadenosine and the 40 kDa protein may be added in larger amounts by adjusting various conditions in the production process of the non-alcoholic beer-taste

### EXAMPLES

Hereinafter, the present invention is specifically described with reference to examples, but the present invention is not limited to the following examples.

### Purification of 2′-deoxyadenosine)

2′-deoxyadenosine (2′DA) was purified as described below.

### (1) Fractionation of Beer by HP-20

Beer (60 L) was fractionated using 10 L Diaion® HP-20 (Mitsubishi Chemical Corporation). The HP-20 was washed with ethanol three times, and then washed with 50% ethanol three times before use. The washed HP-20 was packed in a mass fractionation column and replaced by water. The degassed beer (60 L) was mixed with the same amount of distilled water, and the resulting solution was introduced into the HP-20 column using a medium pressure pump. The solution that passed through the HP-20 column was obtained as a flow-through fraction. Distilled water (40 L) was introduced using a medium pressure pump, and an eluate was obtained as a water-eluted fraction. Likewise, hydrous ethanol (10% ethanol, 30% ethanol, and 70% ethanol) was introduced at an amount of 40 L for each concentration, and eluates were obtained as a 10% ethanol eluted fraction, a 30% ethanol eluted fraction, and a 70% ethanol eluted fraction. These eluted fractions were, dried and refrigerated using an evaporator and a freeze dryer.

### (2) LH-20 Fractionation of 30% Ethanol Eluted Fraction

The 30% ethanol eluted fraction among HP-20 fractions was fractionated using 1.2 kg Sephadex® LH-20. The ethanol washed LH-20 was packed in a mass fractionation column and replaced by water. Then, 17.6 g of the 30% ethanol eluted fraction (87.9 g) obtained by HP-20 fractionation was dissolved in distilled water and applied to the LH-20 column. Distilled water (13.5 L) was introduced using a medium pressure pump, and water eluted fractions 1 to 6 were obtained. Subsequently, hydrous ethanol (35% ethanol, 70% ethanol, and 100% ethanol) was introduced at an amount of 7 L for each concentration, and eluates were obtained as a 35% ethanol eluted fraction, a 70% ethanol eluted fraction, and a 100% ethanol eluted fraction. These eluted fractions were dried and refrigerated. using an evaporator and a freeze dryer.

### (3) Isolation of 2′DA

An amount of 86.4 mg of the water eluted fraction 4 (0.56 g) obtained by LH-20 fractionation was eluted with 10% ethanol using in a HPLC (COSMOSIL 5C18-PAQ, 20×250 mm). Subsequently, an eluate from 10 min to 13 min was concentrated and eluted with a mixture with an ethanol/water concentration gradient (5:95→15:85) using an HPLC (COSMOSIL 5C18-PAQ, 20×250 mm), whereby a compound (I) (0.5 mg, tR=21 min) was obtained.

The compound (I) was identified as 2′-deoxyadenosine from analysis of MS and NMR physical data and comparison with samples.

The following analytical instruments were used. LC-MS: Q Exactive, Thermo Fisher Scientific NMR: AVANCE 400, Bruker

### Purification of 40 kDa Protein

A 40 kDa protein was purified from commercially available beer (1 L) as follows.

### (1) Fractionation by Cation Exchange Resin

A cation-exchange resin “SP Sepharose” (50 ml) was planed in an empty column. Beer adsorbed onto the resin. Subsequently, the resin used for adsorption was transferred to another column, washed with a 20 mM sodium acetate buffer (pH 4.5), and then eluted with 20 mM sodium acetate (pH 4.5)+0.5 M-NaCl, whereby fractions were collected. The resulting fractions were evaluated by SDS-PAGE, and fractions containing a 40 kDa protein were collected as cation-exchange resin-bound fractions.

### (2) Ultrafiltration (Buffer Exchange)

The cation-exchange resin-bound fractions obtained in (1) above were added in increments of 10 mL to an ultrafiltration unit. (Amicon Ultra-15 30K, Merck KGaA) washed with water, and centrifuged at 3500 rpm and ultrafiltered, whereby a concentrate was obtained.

### (3) Ammonium Sulfate Fractionation

The concentrate obtained in (2) above was dropped into a beaker charged with a 20 mM phosphate buffer (pH 7.0) and 2 M ammonium sulfate, followed by stirring. The resulting suspension was then centrifuged (2330 g, 10 min, room temperature). The supernatant was collected in a different container. The collected solution was concentrated using an ultrafiltration unit. To the concentrate was added 20 mM sodium acetate (pH 4.5), followed by centrifugation (2330 g, 10 min, room temperature) for concentration, so that a purified 40 kDa protein product (quantified by the Bradford assay (in bovine serum albumin (BSA) equivalent), 20.4 mg/mL, 2.21 mL) was obtained. The purity of the resulting purified 40 kDa protein was confirmed by SDS-PAGE.

After the 40 kDa protein was digested by an enzyme, identification of the protein was attempted by LC-MS/MS analysis.

The band around 40 kDa isolated by SDS-PAGE was sliced, followed by reduction with dithiothreitol (56° C., 1 hr) and carbamide methylation with iodoacetamide (room temperature under light-shielded conditions, 45 min). Then, a 0.01% ProteaseMAX-containing 10 ng/μL chymotrypsin solution (5 mM calcium chloride, 50. mM ammonium bicarbonate solution) (15 μL), 5 mM calcium chloride, and a 50 mM ammonium bicarbonate solution (15 μL) were added, followed by overnight incubation. Subsequently the resulting enzyme digestion solution was collected. The collected solution was solidified by drying in vacuum, which was then re-dissolved in a 0.1% formic acid solution.

The resulting product was used for LC-MS/MS analysis.

### Measurement by LC-MS/MS

LC-MS/MS measurement was performed under the following conditions.

Device used: direct flow type nano LC system “Easy-nLC 100™” (Thermo Fisher Scientific)
Trap column: Acclaim PepMap® (Thermo Fisher Scientific)
Analysis column: Nano HPLC Capillary Column (Nikkyo Technos Co., Ltd.)
Liquid chromatograph mass spectrometer: Q Exactive Pius (Thermo Fisher Scientific)
Mobile phase: solvent A: 0.1% formic acid/water; solvent B: 0.1% formic acid/acetonitrile
Flow rate: 300 nL/min
Gradient: 0-40% B/0-30 min, 40-60% B/30-35 min, 60-90% B/35-37 min, 90% B/37-45 mm
Amount introduced: 10 μL
Ionization mode: EST Positive
Measurement range: MS1 (m/z 350-750)
Data dependent scan mode

### (4) Analysis of Protein

The protein was identified under the following conditions.

Search software: Proteome Discoverer 2.2.0.388 (Thermo Fisher Scientific)
Species: barley (Hordeum vulgare), hop (Humulus), yeast (Saccharomyces cerevisiae)
Search conditions:
Digestive enzyme: Chymotrypsin
Precursor ion mass error range: Monoisotopic, ±10 ppm
Production mass error range: ±0.02 Da
Maximum number of missed cleavages: 5
Confidence level (Percolator): High (level with the highest confidence of the three levels of confidence)

### Database: SwissProt

As a result, the 40 kDa protein was found to be barley-derived Serpin Z4 (sequence coverage: 77.2) and barley-derived Serpin Z7 (sequence coverage: 72.8%).

### Sensory Evaluation of Commercially Available Non-Alcoholic Beer-Taste Beverage to Which 2′DA is Added

2′-deoxyadenosine (2′DA) was added to a commercially available non-alcoholic beer-taste beverage for sensory evaluation of the fullness.

The non-alcoholic beer-taste beverage is a non-alcoholic beer-taste beverage containing malt in its ingredients.

Raw materials include malt, hops, carbonic acid, flavorings, acidulants, caramel color, vitamin C, bittering agents, and sweeteners. The nutritional components per 100 ml include 0% alcohol content, 0 g protein, 0 g sugar, 0 to 0.1 g dietary fiber, and about 0 mg purine.

Reference points of sensory evaluation are as follows.

Five special panelists rated in increments of 0.05 points based on the following criteria, and the points were averaged.

The criteria, for the intensity of fullness are as follows.

0 points: no fullness at all
1 point: slight fullness
2 points: definite fullness
3 points: very intense fullness

A commercially available alcoholic beer-taste beverage different from the above-described commercially available non-alcoholic beer-taste beverage (the subject of evaluation) was provided as a reference alcoholic beer-taste beverage (I), and its fullness was given 0.7 points as the reference point. Another commercially available alcoholic beer-taste beverage was also provided as a reference alcoholic beer-taste beverage (II), and its fullness was given 1.5 points as the reference point.

The fullness of the commercially available non-alcoholic beer-taste beverage as the subject of evaluation was given 0.5 points based on the fullness of the commercially available alcoholic beer-taste beverages (I) and (II).

The reference alcoholic beer-taste beverage (I) is an alcoholic beer-taste beverage in which the proportion of malt in the mixture of the ingredients is more than 0 wt % and less than 50 wt %.

The raw materials include low-malt beer, malt, hops, sugars, dietary fiber, and spirit (wheat). The nutritional components per 100 ml include, 4% alcohol content, 0 to 0.2 g protein, 0.5 to 0.8 g sugar, and about 2.0 mg purine.

The reference alcoholic beer-taste beverage (II) is an alcoholic beer-taste beverage in which the proportion malt in the mixture of the ingredients is 50 wt. % or more.

The raw materials include malt and hops. The nutritional components per 100 ml include 5.5% alcohol content, 0.4 to 0.6 g protein, 3.6 g sugar, and about 12.5 mg purine.

The procedure for the sensory evaluation is as follows.

(1) The non-alcoholic beer-taste beverage is dispensed into vials at a volume of 1/10 (v/v) of the final volume.
(2) 2′DA is weighed out at a predetermined weight and added to each vial.
(3) The vials are sonicated for 30 seconds.
(4) The vials are left to stand at room temperature for 30 minutes.
(5) The non-alcoholic beer-taste beverage is filled up to the final volume.
(6) The non-alcoholic beer-taste be is dispensed and ingested for evaluation.

### Analysis of Commercially Available Non-Alcoholic Beer-Taste Beverage

The concentration of 2′DA in the commercially available non-alcoholic beer-taste beverage used for the sensory evaluation was quantitated by LC-MS.

### (1) Preparation of Samples and Calibration Curves

2′DA was diluted to the following concentrations and passed through a 0.22 μm filter before measurement. Final concentration: 0.001 ppm, 0.025 ppm, 0.050 ppm, 0.100 ppm, 0.200 ppm, 0.300 ppm, 0.500 ppm, 0.750 ppm, and 1.000 ppm

(1 ppm=1 μg/mL)

A 5% (v/v) aqueous ethanol solution was used as a diluent.

The results of sample analysis were based on values measured at a dilution factor at which the measured values would fall in the range (R²>0.99) maintaining the linearity of the calibration curve.

LC measurement conditions are as follows.

### LC-MS: X500R, AB Sciex Ltd.

Separation column.: HSS T3 1.8 μm, 2.1×150 mm, Waters Eluent:
Solvent A: 0.1% formic acid/water; solvent B: formic acid/acetonitrile
Gradient: solvent A:solvent B=98:2→2:98 (27 min)
Amount introduced: 5 μL
Flow rate: 0.2 mL/min
Column oven: 40° C.

### (MS)

Ionization mode: ESI Positive
Measurement range: MS1 (m/z 100-1000)
Data Independent Scan mode
Ion source temperature: 350° C.

### (2) Preparation of Sample for Measurement from Commercially Available Non-Alcoholic Beer-Taste Beverage

A commercially available non-alcoholic beer-taste beverage was degassed by sonication, appropriately diluted after air bubbles settled, and passed through a 0.22 μm filter before measurement.

A 5% (v/v) aqueous ethanol solution was used as a diluent.

The concentration of 2′DA in the commercially available non-alcoholic beer-taste beverage was used as the control.

### Example 1: Evaluation by Addition of 2′DA

2′DA in the commercially available non-alcoholic beer-taste beverage (control) had a concentration of 0 ppm.

2′DA was added to the non-alcoholic beer-taste beverage such that the concentration of 2′DA would be 1 ppm, 6 ppm, and 10 ppm for sensory evaluation. In addition, 2′DA was added to the commercially available non-alcoholic beer-taste beverage such that the concentration of 2′DA would be 0.1 ppm for sensory evaluation (comparison sample 1).

Table 1 shows the results of the sensory evaluation.

TABLE 1

| | | Comparison | | | |
|---|---|---|---|---|---|
| | Control | sample 1 | Sample 1 | Sample 2 | Sample 3 |
| 2′DA concentration (ppm) | 0 | 0.1 | 1 | 6 | 10 |
| PanelistA | 0.50 | 0.50 | 0.60 | 0.65 | 0.70 |
| PanelistB | 0.50 | 0.50 | 0.55 | 0.60 | 0.65 |
| PanelistC | 0.50 | 0.55 | 0.65 | 0.75 | 0.80 |
| PanelistD | 0.50 | 0.50 | 0.55 | 0.65 | 0.70 |
| PanelistE | 0.50 | 0.50 | 0.60 | 0.70 | 0.80 |
| Average of sensory evaluation | 0.50 | 0.51 | 0.59 | 0.67 | 0.73 |

The results in Table 1 show that the fullness of the non-alcoholic beer-taste beverages is increased when the concentration of 2′DA is 1 ppm or more.

### Example 2: Evaluation of Synergy of 2′DA an 40 kDa Protein

2′DA was added to a commercially available non-alcoholic beer-taste beverage (control) to obtain a beverage containing a 2′DA at a concentration of 1 ppm as a reference, and a 40 kDa protein was further added to the beverage to evaluate the synergy of the 2′PA and the 40 kDa protein. The concentration of the 40 kDa protein was set to 5 ppm and 10 ppm. The 40 kDa protein was one purified above.

For comparison, an evaluation was also performed on a commercially available non-alcoholic beer-taste beverage to which only a 40 kDa protein was added and in which the concentration of the 40 kDa protein was adjusted to 5 ppm (comparison sample 2).

Table 2 shows the results of the sensory evaluation.

TABLE 2

| | | | | | Comparison |
|---|---|---|---|---|---|
| | Control | Sample 1 | Sample 2 | Sample 3 | sample 2 |
| 2′DA concentration (ppm) | 0 | 1 | 1 | 1 | 0 |
| 40 kDa protein concentration | 0 | 0 | 5 | 10 | 5 |
| (ppm) | | | | | |
| PanelistA | 0.50 | 0.60 | 0.65 | 0.75 | 0.50 |
| PanelistB | 0.50 | 0.55 | 0.55 | 0.70 | 0.50 |
| PanelistC | 0.50 | 0.65 | 0.70 | 0.75 | 0.50 |
| PanelistD | 0.50 | 0.55 | 0.70 | 0.80 | 0.50 |
| PanelistE | 0.50 | 0.60 | 0.65 | 0.75 | 0.55 |
| Average of sensory evaluation | 0.50 | 0.59 | 0.65 | 0.75 | 0.51 |

The results in Table 2 show that adding 2′DA to a commercially available non-alcoholic beer-taste beverage and further adding a 40 kDa protein thereto can further increase the fullness.

The results from the comparison sample 2 show that the fullness can be increased by, simply adding a 40 kDa protein. The results also show that the increment (0.15) from the control in the sensory evaluation of the sample 2 is greater than the additive effect (0.10) predictable from the combination of the 2′DA and the 40 kDa protein as determined as the sum of the increment (0.09) from the control in the sensory evaluation of the sample 1 and the increment (0.01) from the control in the sensory evaluation of the comparison sample 2. This indicates unpredictable synergy by the combination of the 2′DA and the 40 kDa protein.

### INDUSTRIAL APPLICABILITY

The present invention can provide a non-alcoholic beer-taste beverage with increased fullness.

1. A non-alcoholic beer-taste beverage comprising
2′-deoxyadenosine at a concentration of 1 ppm or more.

2. The non-alcoholic beer-taste beverage according to claim 1,
wherein the concentration of 2′-deoxyadenosine is 1 to 10 ppm.

3. The non-alcoholic beer-taste beverage according to claim 1, further containing a protein having a molecular weight of 35 to 50 kDa,
wherein the protein has a concentration of 5 ppm or more.

4. The non-alcoholic beer-taste beverage according to claim 3,
wherein the protein has a concentration of 30 ppm or less.
